(19) United States
(12) Patent Application Publication
(10) Pub. No.: US 2017/0242164 A1
(43) Pub. Date: Aug. 24, 2017

(54) DURABLE SOLAR MIRROR FILM WITH ASYMMETRIC CONSTRUCTION

(71) Applicant: 3M INNOVATIVE PROPERTIES COMPANY, Saint Paul, MN (US)

(72) Inventors: MARK B. O'NEILL, STILLWATER, MN (US); DIANE NORTH, INVER GROVE HEIGHTS, MN (US)

(73) Assignee: 3M INNOVATIVE PROPERTIES COMPANY, SAINT PAUL, MN (US)

(21) Appl. No.: 15/121,512

(22) PCT Filed: Mar. 2, 2015
(86) PCT No.: PCT/US15/18297

§ 371 Date: Aug. 25, 2016

Related U.S. Application Data
(60) Provisional application No. 61/947,238, filed on Mar. 3, 2014.

(51) Int. Cl. G02B 5/08; G02B 1/14; G02B 5/20; G02B 1/04

(52) U.S. Cl. CPC G02B 5/0866; G02B 1/04; G02B 1/14; G02B 5/208

(57) ABSTRACT

The present disclosure generally relates to multilayer optical films having an asymmetric construction and durable solar mirror films comprising such multilayer optical films, as well as constructions including durable solar mirror films.

### GOVERNMENT LICENSE RIGHTS

The Government of the United States of America has rights in at least some of the inventions described in this patent application pursuant to government contract no. DE-EE0005795, awarded by the U.S. Department of Energy.

### TECHNICAL FIELD

The present disclosure generally relates to multilayer optical films having an asymmetric construction and durable solar mirror films comprising such multilayer optical films, as well as constructions including durable solar mirror films.

### BACKGROUND

In general, concentrated solar technology involves the collection of solar radiation in order to directly or indirectly produce electricity. The three main types of concentrated solar technology are concentrated photovoltaic, concentrated solar power, and solar thermal.

In concentrated photovoltaic (CPV), concentrated sunlight is converted directly to electricity via the photovoltaic effect. Generally, CPV technology uses optics (e.g. lenses or mirrors) to concentrate a large amount of sunlight onto a small area of a solar photovoltaic material to generate electricity. CPV systems are often much less expensive to produce than other types of photovoltaic energy generation because the concentration of solar energy permits the use of a much smaller number of the higher cost solar cells.

In concentrated solar power (CSP), concentrated sunlight is converted to heat, and then the heat is converted to electricity. Generally, CSP technology uses mirrored surfaces in multiple geometries (e.g., flat mirrors, parabolic dishes, and parabolic troughs) to concentrate sunlight onto a receiver. That, in turn, heats a working fluid (e.g. a synthetic oil or a molten salt) or drives a heat engine (e.g., steam turbine). In some cases, the working fluid is what drives the engine that produces electricity. In other cases, the working fluid is passed through a heat exchanger to produce steam, which is used to power a steam turbine to generate electricity.

Solar thermal systems collect solar radiation to heat water or to heat process streams in industrial plants. Some solar thermal designs make use of reflective mirrors to concentrate sunlight onto receivers that contain water or the feed stream. The principle of operation is very similar to concentrated solar power units, but the concentration of sunlight, and therefore the working temperatures, are not as high.

The rising demand for solar power has been accompanied by a rising demand for reflective devices and materials capable of fulfilling the requirements for these applications. Some of these solar reflector technologies include glass mirrors, aluminized mirrors, and metalized polymer films. Of these, metalized polymer films are attractive in certain applications because they are lightweight, offer design flexibility, and potentially enable less expensive installed system designs than conventional glass mirrors. Polymers are lightweight, inexpensive, and easy to manufacture. In order to achieve metal surface properties on a polymer, thin layers of metal (e.g. silver) are coated on the polymer surface.

### SUMMARY

The metalized polymer films used in concentrated solar power units and concentrated photovoltaic cells are used outdoors and subject to continuous exposure to the elements. Consequently, a technical challenge in designing and manufacturing metalized polymer reflective films is achieving long-term (e.g., 20 years) durability when subjected to harsh environmental conditions. There is a need for metalized polymer films that provide durability and retained optical performance (e.g., reflectivity) once installed in a concentrated solar power unit or a concentrated photovoltaic cell. Mechanical properties, optical clarity, corrosion resistance, ultraviolet light stability, and resistance to outdoor weather conditions are some of the factors that can contribute to the gradual degradation of materials over an extended period of operation.

The inventors of the present disclosure recognized that many of the technical problems in forming a durable metalized polymer film capable of long-term outdoor use that retains its optical performance arise from a mismatch in the physical and chemical nature and properties of metals and polymers. One particular difficulty relates to ensuring good adhesion between the polymer layer and the metal reflective surface. Without good adhesion between these surfaces/layers, delamination occurs. The inventors have observed that certain metalized solar mirror films delaminate between the polymer layer and the reflective layer after outdoor exposure in a manner known as “tunneling,” as the defect resembles a worm tunnel in appearance.

The inventors of the present disclosure recognized that tunneling typically results from decreased adhesion between the polymer layer and the reflective layer. This decreased adhesion can be caused by any of numerous factors—and often a combination of these factors. Some exemplary factors that the inventors of the present disclosure recognized include (1) increased mechanical stress between the polymer layer and the reflective layer; (2) oxidation of the reflective layer; (3) oxidation of an adhesive adjacent to the reflective layer; and (4) degradation of the polymer layer (this can be due to, for example, exposure to sunlight). Each of these factors can be affected by numerous external conditions, such as, for example, environmental temperature (including variations in environmental temperatures), thermal shock, humidity, exposure to moisture, exposure to air impurities such as, for example, salt and sulfur, UV exposure, product handling, and product storage.

Elimination of tunneling translates into increased lifetime of solar mirror films and increased value over traditional glass mirrors. In some cases tunneling has shown to be more of a cosmetic concern as power output of the solar application showed no or minor reduction. In the long term however, a loss in adhesion will likely lead to total delamination of film layers and corrosion of the metal layer.

The inventors have observed that some of these delamination defects can be mitigated by sealing or treating the edges of the solar mirror film construction. However, those treatments increase processing time and costs as they involve additional materials and steps in the manufacturing/installation of the solar mirror films. Certain embodiments of the present disclosure are directed to solar mirror films in which tunneling is minimized or eliminated completely without necessarily having to seal the edge of the mirror film.

In this application, all scientific and technical terms have meanings commonly used in the art unless otherwise specified. The definitions provided herein are to facilitate understanding of certain terms used frequently herein and are not meant to exclude a reasonable interpretation of those terms in the context of the present disclosure.

Unless otherwise indicated, all numbers in the description and the claims expressing feature sizes, amounts, and physical properties used in the specification and claims are to be understood as being modified in all instances by the term “about.” Accordingly, unless indicated to the contrary, the numerical parameters set forth in the foregoing specification (including examples) and attached claims are approximations that can vary depending upon the desired properties sought to be obtained by those skilled in the art utilizing the teachings disclosed herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The recitation of numerical ranges by endpoints includes all numbers subsumed within that range (e.g. a range from 1 to 5 includes, for instance, 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The term “polymer” will be understood to include homopolymers, copolymers (e.g., polymers formed using two or more different monomers), oligomers and combinations thereof, as well as polymers, oligomers, or copolymers that can be formed in a miscible blend, for example, by co-extrusion or by reaction, including transesterification. The terms “polymer” and “copolymer” include both random and block copolymers.

The term “adjacent” refers to the relative position of two elements that are close to each other and may or may not be necessarily in contact with each other or have one or more layers separating the two elements as understood by the context in which “adjacent” appears.

The term “adhesive” refers to polymeric compositions useful to adhere together two components (adherents). Examples of adhesives include heat activated adhesives and pressure sensitive adhesives.

### DETAILED DESCRIPTION

The present disclosure is directed to multilayer optical films, and solar mirror films comprising such multilayer optical films, that provide exceptional adhesion of the reflective layer to the substrate layer to which the reflective layer is deposited such that tunneling and the associated delamination are substantially decreased, even after exposure to prolonged outdoor conditions. The solar mirror film of this disclosure can be used in concentrated photovoltaic (CPV) and concentrated solar power (CSP) systems.

In one embodiment, the present disclosure is directed to a multilayer optical film (MOF) that comprises two outer polymeric layers (first and second outer layers) and one core layer that comprises a multilayer optical stack, which comprises two alternating polymeric layers. In some embodiments, the two outer layers are different from each other in their polymeric composition. Each of the two outer layers can comprise one or more polymers or blends of polymers and copolymers. In certain embodiments, one or both of the outer layers are part of the multilayer optical stack, representing the outer or protective (if present) layer(s) of the multilayer optical stack. In other embodiments, the two outer layers are separate from the multilayer optical stack and their polymeric compositions are different from those of the two alternating polymeric layers in the multilayer optical stack.

In one embodiment, the first outer layer comprises a blend of one or more acrylate polymers and one or more fluoropolymers. In one embodiment, the first outer layer comprises polymethyl(meth)acrylate and PVDF. The inventors intend the first outer layer to be the outer layer that faces the sun when the multilayer optical film is used as part of a solar mirror film. Accordingly, in certain embodiments, the first outer layer can be protected with an additional layer than can be coated, co-extruded, or laminated onto the first outer layer. In some embodiments, that additional layer is a hardcoat comprising acrylate polymers.

In another embodiment, the second outer layer (i.e., the outer layer that faces a reflective layer when the multilayer optical film is used as part of a solar mirror film) comprises one or more polyesters. In one embodiment, the polyester is polyethylene terephthalate.

In certain embodiments, the multilayer optical stack comprises alternating polymeric layers of a polyester and an acrylic polymer, such as, for example, alternating polymeric layers of polyethylene terephthalate and a copolymer of polymethyl(meth)acrylate.

In certain embodiments, the multilayer optical stack and the first and second outer layers are co-extruded. In other embodiments, the first and second outer layers are laminated on the multilayer optical stack. In certain embodiments, coextruding the first and second outer layers along with the multilayer optical stack provides protection to the multilayer optical stack during further processing.

In some embodiments, when the multilayer optical film is used as part of a solar mirror film, the solar mirror film further comprises a reflective layer, which can comprise a metal chosen from gold, silver, aluminum, copper, nickel, titanium, and combinations thereof. In some embodiments, the solar mirror film does not contain an adhesive or primer layer between the second outer layer and the metallic layer and in other embodiments such adhesive or primer layers are present. Optionally, some embodiments comprise an additional layer adjacent the metallic layer to protect it from potential corrosion. That corrosion-resistance layer can be entirely polymeric or can comprise a metal. In one embodiment, the corrosion-resistance layer comprises a metal chosen from copper, an inert metal alloy, and combinations thereof.

Certain embodiments of the solar mirror films of this disclosure include a premask to facilitate roll formation and handling. The premask can be adjacent the protective layer, if present, or adjacent the first outer layer.

In one exemplary embodiment, a solar mirror film includes, in the following order, a premask layer, a protective layer, such as, for example, a hardcoat, a first outer layer, a multilayer optical stack, a second outer layer, a metallic layer (including, for example, a reflective metal), a second metallic layer comprising a metal that can act as an agent to minimize corrosion of the first metallic layer, an adhesive layer, and a liner.

As mentioned above, the multilayer optical films and the solar mirror films of the present disclosure have exceptional adhesion between the reflective layer and the second outer layer, which decreases or eliminates delamination. In certain embodiments, after exposure to at least 100 MJ/m² UV, the interlayer adhesion (see Examples section for a method of measuring this parameter) between the reflective layer and the second outer layer is degraded less than 50 percent of its original value, or less than 40 percent of its original value, or less than 30 percent of its original value, or less than 20 percent of its original value, or less than 10 percent of its original value, or less than 5 percent of its original value.

In other embodiments, after exposure to at least 200 MJ/m² UV, the interlayer adhesion between the reflective layer and the second outer layer is degraded less than 50 percent of its original value, or less than 40 percent of its original value, or less than 30 percent of its original value, or less than 20 percent of its original value, or less than 10 percent of its original value, or less than 5 percent of its original value.

In other embodiments, after exposure to at least 300 MJ/m² UV, the interlayer adhesion between the reflective layer and the second outer layer is degraded less than 50 percent of its original value, or less than 40 percent of its original value, or less than 30 percent of its original value, or less than 20 percent of its original value, or less than 10 percent of its original value, or less than 5 percent of its original value.

In other embodiments, after exposure to at least 350 MJ/m² UV, the interlayer adhesion between the reflective layer and the second outer layer is degraded less than 50 percent of its original value, or less than 40 percent of its original value, or less than 30 percent of its original value, or less than 20 percent of its original value, or less than 10 percent of its original value, or less than 5 percent of its original value.

In some embodiments, the percent delamination between the hardcoat and the first outer layer in a cross-hatch adhesion test (see Examples section for a method of measuring this parameter, including preconditioning the samples in deionized water) is less than 60 percent. In other embodiments, the percent delamination between the hardcoat and the first outer layer in a cross-hatch adhesion test is less than 55 percent, or less than 50 percent, or less than 45 percent, or less than 40 percent, or less than 35 percent, or less than 30 percent, or less than 25 percent, or less than 20 percent, or less than 15 percent, or less than 10 percent, or less than 5 percent.

Although various features of the multilayer optical films and solar mirror films described throughout the present description are illustrated as separate embodiments for ease of disclosure, the inventors contemplate that one or more of those separate embodiments may and should be combined to describe multilayer optical films and solar mirror films within the scope of the instant disclosure.

Premask Layer

The premask layer is optional. Where present, the premask protects the weatherable layer during handling, lamination, and installation. Such a configuration can then be conveniently packaged for transport, storage, and consumer use. In some embodiments, the premask is opaque to protect operators during outdoor installations. In some embodiments, the premask is transparent to allow for inspection for defects. Any known premask can be used. In one embodiment, the premask comprises polyethylene and is from 1.5 to 2 mils thick. In another embodiment, the premask is from 1.7 mils thick. One exemplary commercially available premask is ForceField® 1035 sold by Tredegar of Richmond, Va. Another layer used to aid in winding rolls of film includes a polyethylene self-adhesion-type masking film, such as FM585P Masking Film from Daio Paper Products, Osaka, Japan.

Protective Layer

The protective layer is optional. In certain embodiments, in order to protect the multilayer optical film, the exposed surface of the film can be protected with an additional layer than can be coated, co-extruded, or laminated onto the first outer layer. In one embodiment, the first outer layer can be coated with a scratch and wear resistant hardcoat. The hardcoat layer can improve the durability and weatherability of the multilayer optical film during processing and during use of the end product. The hardcoat layer can include any useful material, such as acrylic hardcoats, silica-based hardcoats, siloxane hardcoats, melamine hardcoats, and the like. In the case of acrylic hardcoats, the hardcoat can contain one or more acrylic polymers. Acrylic polymers include acrylates, methacrylates, and their copolymers. In one embodiment, the hardcoat comprises more than 90% (weight percent on a dry basis) of acrylic polymers. In another embodiment, the hardcoat comprises a blend of 1,6-Hexanediol diacrylate (HDDA), which can be available from Sartomer USA, LLC, and BASF Paraloid B44.

The hardcoat can be any useful thickness such as, for example, from 1 to 20 micrometers, or 1 to 10 micrometers, or 1 to 5 micrometers, or from 5 to 10 micrometers, or from 8 to 12 micrometers. In one embodiment, the thickness of the hardcoat is 9 micrometers. In another embodiment, the thickness of the hardcoat is 10 micrometers.

In one embodiment, the hardcoat layer can include UV stabilizers (see below), anti-oxidizers, such as TINUVIN 123, available from BASF Corporation, and the crosslinking agents and initiators necessary to cure the hardcoat polymers, such as, for example, IRGACURE 184, and IRGACURE 819, also available from BASF Corporation. In one embodiment, the hardcoat comprises from 1 to 7% of UV stabilizers (weight percent on a dry basis). In another embodiment, the hardcoat comprises from 2 to 6% of UV stabilizers (weight percent on a dry basis). In other embodiments, the hardcoat comprises 6% or less, or 5% or less, or 4% or less, or 3% or less of UV stabilizers in weight percent on a dry basis. The nature of the hardcoat or any other protective layer is not critical to the performance of the multilayer optical film as a solar mirror film and the inventors envision that known clear hardcoats or protective layers may be used adjacent the first outer layer of the multilayer optical film.

Outer Layers

An outer layer may be coextruded on each of the major surfaces of the multilayer stack during its manufacture to provide desirable properties to the multilayer optical stack and to protect it from shear along the feedblock and die walls.

In some embodiments, the first outer layer comprises a blend of one or more acrylate polymers and one or more fluoropolymers. As used herein, acrylate polymers include acrylates, methacrylates, and their copolymers. Examples of such polymers include polyacrylates, polymethacrylates, such as poly (methyl methacrylate) (PMMA), either as homopolymers or copolymers, such as a coPMMA made from 75 wt % methylmethacrylate (MMA) monomers and 25 wt % ethyl acrylate (EA) monomers, (available from Ineos Acrylics, Inc., under the trade designation Perspex CP63), a coPMMA formed with MMA comonomer units and n-butyl methacrylate (nBMA) comonomer units.

In certain embodiments, the fluoropolymer used in the polymeric blend of the first outer layer is a material that is capable of being extruded. In some embodiments, the fluoropolymer may be a partially fluorinated polymer. For example, the fluoropolymer may be either melt-processible such as in the case of polyvinylidene fluoride (PVDF), a terpolymer of tetrafluoroethylene, hexafluoropropylene and vinylidene fluoride (THV), and other melt-processible fluoroplastics, or may be non-melt processable such as in the case of modified PTFE copolymers, such as a copolymer of TFE and low levels of fluorinated vinyl ethers and fluoroelastomers. Fluoroelastomers may be processed before they are cured by injection or compression molding or other methods normally associated with thermoplastics. Fluoroelastomers after curing or crosslinking may not be able to be further processed. Fluoroelastomers may also be coated out of solvent in their uncross linked form. In one embodiment, the fluoropolymer blended with the acrylic polymer is PVDF.

In other embodiments, the fluoropolymer is a fluoroplastic including interpolymerized units derived from VDF and fluoroethylene and may further include interpolymerized units derived from other fluorine-containing monomers, non-fluorine-containing monomers, or a combination thereof. Examples of suitable fluorine containing monomers include tetrafluoroethylene (TFE), hexafluoropropylene (HFP), chlorotrifluoroethylene (CTFE), 3-chloropentafluoropropene, perfluorinated vinyl ethers (e.g., perfluoroalkoxy vinyl ethers such as CF₃0CF₂CF₂CF₂0CF=CF₂ and perfluoroalkyl vinyl ethers such as CF₃0CF=CF₂ and CF₃CF₂CF₂0CF=CF₂), vinyl fluoride, and fluorine-containing di-olefins such as perfluorodiallylether and perfluoro-1,3-butadiene. Examples of suitable nonfluorine-containing monomers include olefin monomers such as ethylene, propylene, and the like.

VDF-containing fluoroplastics may be prepared using emulsion polymerization techniques as described, e.g., in Sulzbach et al., U.S. Pat. No. 4,338,237 or Grootaert, U.S. Pat. No. 5,285,002, hereby incorporated by reference. Useful commercially available VDF-containing fluoroplastics include, for example, THV™ 200, THV™ 400, THV™ 5000, THV™ 610 X fluoropolymers (available from Dyneon LLC, St. Paul, Minn.), KYNAR™ 740 fluoropolymer (available from Atochem North America, Philadelphia, Pa.), HYLAR™ 700 (available from Ausimont USA, Inc., Morristown, N.J.), and FLUOREL™ FC-2178 (available from Dyneon LLC).

Other examples of fluoropolymers include THV™ (a terpolymer of CF₂=CF₂/CF₃CF=CF₂/CF₂=CH₂), THE (a terpolymer of CF₂=CF₂/CF₃CF=CF₂/CH₂=CH₂), PVDF-HV (a copolymer CF₂=CH₂ (85 wt %) and CF₃CF=CF₂ (15 wt %)) and PVDF-CV (a copolymer of CF₂=CH₂ (85 wt %) and CF₂=CFCl (15 wt %)).

In some embodiments, on a dry basis, the first outer layer comprises from 50% to 70% of the one or more acrylate polymers and from 25% to 40% of the one or more fluoropolymer. In other embodiments, the first outer layer comprises from 60% to 65% of the one or more acrylate polymers and from 30% to 35% of the one or more fluoropolymer. In other embodiments, the first outer layer comprises 63% of the one or more acrylate polymers and 35% of the one or more fluoropolymer. In certain embodiments, the one or more acrylate polymers is PMMA and the one or more fluoropolymer is PVDF.

In some embodiments, the first outer layer comprises additives, such as, for example, one or more UV stabilizers. In some embodiments, the first outer layer comprises from 0 to 5% of a UV stabilizer. In some embodiments, the first outer layer comprises 1%, or 2%, or 3%, or 4%, or 5% of a UV stabilizer. In other embodiments, the UV stabilizer is Tin-1600.

In certain embodiments, the second outer layer comprises one or more polyesters. In one embodiment, the polyesters include crystalline or semi-crystalline polyesters, copolyesters, and modified copolyesters. In this context, the term “polyester” includes homopolymers and copolymers. Polyesters suitable for use in the second outer layer generally include carboxylate and glycol subunits and can be generated by reactions of carboxylate monomer molecules with glycol monomer molecules. Each carboxylate monomer molecule has two or more carboxylic acid or ester functional groups and each glycol monomer molecule has two or more hydroxy functional groups. The carboxylate monomer molecules may all be the same or there may be two or more different types of molecules. The same applies to the glycol monomer molecules. Also included within the term “polyester” are polycarbonates derived from the reaction of glycol monomer molecules with esters of carbonic acid.

Suitable carboxylate monomer molecules for use in forming the carboxylate subunits of the polyester include, for example, terephthalic acid; isophthalic acid; 2,6-naphthalene dicarboxylic acid and isomers thereof; phthalic acid; azelaic acid; adipic acid; sebacic acid; norbornene dicarboxylic acid; bi-cyclo-octane dicarboxylic acid; 1,4-cyclohexane dicarboxylic acid and isomers thereof; t-butyl isophthalic acid, trimellitic acid, sodium sulfonated isophthalic acid; 4,4′-biphenyl dicarboxylic acid and isomers thereof; and lower alkyl esters of these acids, such as methyl or ethyl esters. The term “lower alkyl” refers, in this context, to C₁-C₁₀ straight-chained or branched alkyl groups.

Suitable glycol monomer molecules for use in forming glycol subunits of the polyester include ethylene glycol; propylene glycol; 1,4-butanediol and isomers thereof; 1,6-hexanediol;

neopentyl glycol; polyethylene glycol; diethylene glycol; tricyclodecanediol; 1,4-cyclohexanedimethanol and isomers thereof; norbornanediol; bicyclo-octanediol; trimethylol propane; pentaerythritol; 1,4-benzenedimethanol and isomers thereof; bisphenol A; 1,8-dihydroxy biphenyl and isomers thereof; and 1,3-bis (2-hydroxyethoxy)benzene. An exemplary polymer useful as the birefringent layer in the multilayer optical stacks of the present disclosure is polyethylene terephthalate (PET). Another useful birefringent polymer is polyethylene naphthalate (PEN). In one embodiment, the one or more polyesters of the second outer layer are made of 100% PET.

In some embodiments, each of the outer layers has a thickness of from 6 micrometer to 12 micrometers. In some embodiments, each of the outer layers has a thickness of 9 micrometers. In some embodiments, each of the outer layers has a thickness of at least 10 micrometers, at least 50 micrometers, or at least 60 micrometers. Additionally, in some embodiments, each of the outer layers has a thickness no greater than 200 micrometers, no greater than 150 micrometers or no greater than 100 micrometers. In some embodiments, each of the outer layers has a thickness no greater than 5 micrometers.

Multilayer Optical Stack

In one embodiment, the multilayer optical stack comprises alternating layers of at least one birefringent polymer and one second polymer. The multilayer optical stacks are generally a plurality of alternating polymeric layers, which can be selected to achieve the reflection of a specific bandwidth of electromagnetic radiation.

Materials suitable for making the at least one birefringent layer of the multilayer optical stack of the present disclosure include crystalline, semi-crystalline, or liquid crystalline polymers (e.g., polyesters, copolyesters, and modified copolyesters). In this context, the term “polymer” will be understood as previously defined. Polyesters suitable for use in some exemplary multilayer optical stacks constructed according to the present disclosure generally include carboxylate and glycol subunits and can be generated by reactions of carboxylate monomer molecules with glycol monomer molecules. Each carboxylate monomer molecule has two or more carboxylic acid or ester functional groups and each glycol monomer molecule has two or more hydroxy functional groups. The carboxylate monomer molecules may all be the same or there may be two or more different types of molecules. The same applies to the glycol monomer molecules. Also included within the term “polyester” are polycarbonates derived from the reaction of glycol monomer molecules with esters of carbonic acid.

Suitable carboxylate monomer molecules for use in forming the carboxylate subunits of the polyester layers include, for example, 2,6-naphthalene dicarboxylic acid and isomers thereof; terephthalic acid; isophthalic acid; phthalic acid; azelaic acid; adipic acid; sebacic acid; norbornene dicarboxylic acid; bi-cyclo-octane dicarboxylic acid; 1,4-cyclohexane dicarboxylic acid and isomers thereof; t-butyl isophthalic acid, trimellitic acid, sodium sulfonated isophthalic acid; 4,4′-biphenyl dicarboxylic acid and isomers thereof; and lower alkyl esters of these acids, such as methyl or ethyl esters. The term “lower alkyl” refers, in this context, to C₁-C₁₀ straight-chained or branched alkyl groups.

Suitable glycol monomer molecules for use in forming glycol subunits of the polyester layers include ethylene glycol; propylene glycol; 1,4-butanediol and isomers thereof; 1,6-hexanediol; neopentyl glycol; polyethylene glycol; diethylene glycol; tricyclodecanediol; 1,4-cyclohexanedimethanol and isomers thereof; norbornanediol; bicyclo-octanediol; trimethylol propane; pentaerythritol; 1,4-benzenedimethanol and isomers thereof; bisphenol A; 1,8-dihydroxy biphenyl and isomers thereof; and 1,3-bis (2-hydroxyethoxy)benzene.

An exemplary polymer useful as the birefringent layer in the multilayer optical stacks of the present disclosure is polyethylene terephthalate (PET). Another useful birefringent polymer is polyethylene naphthalate (PEN). The molecular orientation of the birefringent polymer may be increased by stretching the material to greater stretch ratios and holding other stretching conditions fixed. Copolymers of PEN (CoPEN), such as those described in U.S. Pat. No. 6,352,761 and U.S. Pat. No. 6,449,093 are useful for their low temperature processing capability making them more coextrusion compatible with less thermally stable second polymers. Other semicrystalline polyesters suitable as birefringent polymers include, for example, polybutylene 2,6-naphthalate (PBN) and copolymers thereof, as well as copolymers of polyethylene terephthalate (PET) such as those described in U.S. Pat. No. 6,449,093 B2 or U.S. Pat. App. Pub. No. 20060084780, which are incorporated herein by reference for their disclosure of birefringent polymers and polyesters. Alternatively, syndiotactic polystyrene (sPS) is another useful birefringent polymer.

The second polymer of the multilayer optical stack can be made from a variety of polymers having glass transition temperatures compatible with that of the first birefringent polymer and having a refractive index similar to the isotropic refractive index of the birefringent polymer. Examples of other polymers suitable for use in optical stacks as the second polymer include vinyl polymers and copolymers made from monomers such as vinyl naphthalenes, styrene, maleic anhydride, acrylates, and methacrylates. Examples of such polymers include polyacrylates, polymethacrylates, such as poly (methyl methacrylate) (PMMA), and isotactic or syndiotactic polystyrene. Other polymers include condensation polymers such as polysulfones, polyamides, polyurethanes, polyamic acids, and polyimides. In addition, the second polymer can be formed from homopolymers and copolymers of polyesters, polycarbonates, fluoropolymers, and polydimethylsiloxanes, and blends thereof.

Other exemplary suitable polymers, for use as the second polymer, include homopolymers of polymethylmethacrylate (PMMA), such as those available from Ineos Acrylics, Inc., Wilmington, Del., under the trade designations CP71 and CP80, or polyethyl methacrylate (PEMA), which has a lower glass transition temperature than PMMA. Additional second polymers include copolymers of PMMA (coPMMA), such as a coPMMA made from 75 wt % methylmethacrylate (MMA) monomers and 25 wt % ethyl acrylate (EA) monomers, (available from Ineos Acrylics, Inc., under the trade designation Perspex CP63), a coPMMA formed with MMA comonomer units and n-butyl methacrylate (nBMA) comonomer units, or a blend of PMMA and poly(vinylidene fluoride) (PVDF).

Yet other suitable polymers, useful as the second polymer, include polyolefm copolymers such as poly (ethylene-co-octene) (PE-PO) available from Dupont Performance Elastomers under the trade designation Engage 8200, poly (propylene-co-ethylene) (PPPE) available from Fina Oil and Chemical Co., Dallas, Tex., under the trade designation Z9470, and a copolymer of atactic polypropylene (aPP) and isotatctic polypropylene (iPP). The multilayer optical stacks can also include, for example in the second polymer layers, a functionalized polyolefin, such as linear low density polyethylene-g-maleic anhydride (LLDPE-g-MA) such as that available from E.I. duPont de Nemours & Co., Inc., Wilmington, Del., under the trade designation Bynel 4105.

In one embodiment, polymer compositions suitable as the second polymer in alternating layers with the at least one birefringent polymer include PMMA, CoPMMA, polydimethyl siloxane oxamide based segmented copolymer (SPDX), fluoropolymers including homopolymers such as PVDF and copolymers such as those derived from tetrafluoroethylene, hexafluoropropylene, and vinylidene fluoride (THV), blends of PVDF/PMMA, acrylate copolymers, styrene, styrene copolymers, silicone copolymers, polycarbonate, polycarbonate copolymers, polycarbonate blends, blends of polycarbonate and styrene maleic anhydride, and cyclic-olefin copolymers.

The selection of the polymer compositions used in creating the multilayer optical stack can be influenced by the desire to reflected a given bandwidth of incoming radiation. Higher refractive index differences between the birefringent polymer and the second polymer create more optical power thus enabling more reflective bandwidth. Alternatively, additional layers may be employed to provide more optical power. Examples of combinations of birefringent layers and second polymer layers may include, for instance, the following: PET/coPMMA, PET/THV, PET/SPDX, PEN/THV, PEN/SPDX, PEN/PMMA, PEN/CoPMMA, CoPEN/PMMA, CoPEN/SPDX, sPS/SPDX, sPS/THV, CoPEN/THV, PET/fluoroelastomers, sPS/fluoroelastomers and CoPEN/fluoroelastomers.

Exemplary multilayer optical stacks of the present disclosure may be prepared, for example, using the apparatus and methods disclosed in U.S. Pat. No. 6,783,349, entitled “Apparatus for Making Multilayer Optical Films,” U.S. Pat. No. 6,827,886, entitled “Method for Making Multilayer Optical Films,” and PCT Publication Nos. WO 2009/140493 entitled “Solar Concentrating Mirror” and WO 2011/062836 entitled “Multi-layer Optical Films,” all of which are incorporated herein by reference in their entireties. Examples of additional layers or coatings suitable for use with exemplary multilayer optical stacks of the present disclosure are described, for example, in U.S. Pat. Nos. 6,368,699, and 6,459,514 both entitled “Multilayer Polymer Film with Additional Coatings or Layers,” both of which are incorporated herein by reference in their entireties.

In some embodiments, the multilayer optical stack may have spectral regions of high reflectivity (>90%) and other spectral regions of high transmissivity (>90%). In some embodiments, the multilayer optical stack provides high optical transmissivity over a portion of the solar spectrum and low haze and yellowing, good weatherability, good abrasion, scratch, and crack resistance during to handling and cleaning, and good adhesion to other layers, for example, other (co)polymer layers, metal oxide layers, and metal layers applied to one or both major surfaces of the films when used as substrates, for example, in compact electronic display and/or solar energy applications.

Inclusion of the multilayer optical stack in the solar mirror film construction can, in some embodiments, be introduced as in-line processes.

As is known in the art, one way to produce a multilayer mirror film is to biaxially stretch a multilayer stack. In certain embodiments, for a high efficiency reflective film, average transmission along each stretch direction at normal incidence over the visible spectrum (380-750 nm) is less than 10 percent (reflectance greater than 90 percent), or less than 5 percent (reflectance greater than 95 percent), or less than 2 percent (reflectance greater than 98 percent). In one embodiment, the average transmission along each stretch direction at normal incidence over the visible spectrum (380-750 nm) is less than 1 percent (reflectance greater than 99 percent).

In other embodiments, the average transmission along each stretch direction at normal incidence over the wavelength region 380-1500 nm is less than 10 percent (reflectance greater than 90 percent), or less than 5 percent (reflectance greater than 95 percent), or less than 2 percent (reflectance greater than 98 percent), or less than 1 percent (reflectance greater than 99 percent).

In other embodiments, the average transmission at 60 degrees from the normal from 380-750 nm is less than 20 percent (reflectance greater than 80 percent), less than 10 percent (reflectance greater than 90 percent), less than 5 percent (reflectance greater than 95 percent), less than 2 percent (reflectance greater than 98 percent), or less than 1 percent (reflectance greater than 99 percent).

Tie Layer

A tie layer is optional. In the embodiments that contain a tie layer, the tie layer may include a metal oxide such as aluminum oxide, copper oxide, titanium dioxide, silicon dioxide, or combinations thereof. The inventors have observed, that as a tie layer, titanium dioxide provides high resistance to delamination in dry peel and wet peel testing. Further options and advantages of metal oxide tie layers are described in U.S. Pat. No. 5,361,172 (Schissel et al.), incorporated by reference herein.

In certain embodiments, the tie layer has a thickness of equal to or less than 500 micrometers. In some embodiments, the tie layer has a thickness of between 0.1 micrometer and 5 micrometers. In some embodiments, the tie layer has an overall thickness of at least 0.1 nanometers, at least 0.25 nanometers, at least 0.5 nanometers, or at least 1 nanometer. In some embodiments, the tie layer has an overall thickness no greater than 2 nanometers, no greater than 5 nanometers, no greater than 7 nanometers, or no greater than 10 nanometers.

Reflective Layer

The solar mirror films described herein include one or more reflective layers. Besides providing a high degree of reflectivity, the reflective layer(s) can provide manufacturing flexibility. Optionally, the reflective layer may be applied onto a relatively thin organic tie layer or inorganic tie layer.

In some embodiments, the reflective layer(s) have smooth, reflective metal surfaces that are specular. As used herein, the term “specular surfaces” refer to surfaces that induce a mirror-like reflection of light in which the direction of incoming light and the direction of outgoing light form the same angle with respect to the surface normal. Any reflective metal may be used for this purpose. Exemplary metals include silver, gold, aluminum, copper, nickel, and titanium. In some embodiments, the reflective layer includes elemental silver.

The reflective layer need not extend across the entire major surface of the layer on which it is deposited (substrate layer). If desired, the substrate layer can be masked during the deposition process such that the reflective layer is applied onto only a pre-determined portion of the substrate layer.

Patterned deposition of the reflective layer onto the multilayer optical film or any other suitable substrate layer is also possible. Exemplary ways of creating a pattern in the reflective layer are described, for example, in U.S. Publication No. 2013/165938, published 7 Nov. 2013, entitled Durable Solar Mirror Films, inventors Andrew J. Henderson, et al.; U.S. Publication No. 2013/037562, published 7 Nov. 2013, entitled Durable Solar Mirror Films, inventors Attila Molnar et al.; and U.S. Publication No. 2013/165727, published 7 Nov. 2013, entitled Durable Solar Mirror Films, inventor Andrew J. Henderson, all assigned to the present applicant and all incorporated herein in their entirety.

Application of the metal to the polymer can be achieved using numerous coating methods including, for example, physical vapor deposition via sputter coating, evaporation via e-beam or thermal methods, ion-assisted e-beam evaporation, electro-plating, spray painting, vacuum deposition, and combinations thereof. The metallization process is chosen based on the polymer and metal used, the cost, and many other technical and practical factors.

Physical vapor deposition (PVD) of metals is popular for some applications because it provides the purest metal on a clean interface. In this technique, atoms of the target are ejected by high-energy particle bombardment so that they can impinge onto a substrate to form a thin film. The high-energy particles used in sputter-deposition are generated by a glow discharge, or a self-sustaining plasma created by applying, for example, an electromagnetic field to argon gas.

In one exemplary method, the deposition process continues for a sufficient duration to build up a suitable layer thickness of the reflective layer on the substrate layer, thereby forming the reflective layer.

The thickness of the reflective layer is chosen to be thick enough to reflect the desired amount of the solar spectrum of light. The thickness can vary depending on the composition of the reflective layer. The thickness of the reflective metal or metalized layer can be selected to provide the desired reflectivity. By adjusting the thickness of the metal layer for a particular metal, the reflective layer can provide the desired reflectivity in the desired bandwidth. In some exemplary embodiments, the reflective layer is between 75 nanometers to 100 nanometers thick for metals such as silver, aluminum, copper, and gold. In one embodiment, the reflective layer is 100 nm thick. In some embodiments, two or more reflective layers may be used.

In other embodiments, the reflective layer has a thickness no greater than 500 nanometers. In some embodiments, the reflective layer has a thickness of from 80 nm to 250 nm. In some embodiments, the reflective layer has a thickness of at least 25 nanometers, at least 50 nanometers, at least 75 nanometers, at least 90 nanometers, or at least 100 nanometers. Additionally, in some embodiments, the reflective layer has a thickness no greater than 100 nanometers, no greater than 110 nanometers, no greater than 125 nanometers, no greater than 150 nanometers, no greater than 200 nanometers, no greater than 300 nanometers, no greater than 400 nanometers, or no greater than 500 nanometers.

Corrosion Resistant Layer

The corrosion resistant layer is optional. Where included, the corrosion resistant layer may include, for example, elemental copper. Use of a copper layer that acts as a sacrificial anode can provide a reflective article with enhanced corrosion-resistance and outdoor weatherability. As another approach, a relatively inert metal alloy such as Inconel (an iron-nickel alloy) can also be used. In one embodiment, the corrosion resistance layer comprises a combination of copper and an inert metal alloy.

The thickness of the corrosion resistant layer is chosen to be thick enough to provide the desired amount of corrosion resistance. The thickness can vary depending on the composition of the corrosion resistant layer. In some exemplary embodiments, the corrosion resistant layer is between 20 nanometers to 50 nanometers thick. In other embodiments, the corrosion resistant layer is between 20 nanometers and 40 nanometers thick. In other embodiments, the corrosion resistant layer is between 25 nanometers and 35 nanometers thick. In one embodiment, the corrosion resistant layer is 30 nm thick. In some embodiments, two or more corrosion resistant layers may be used.

In some embodiments, the corrosion resistant layer has a thickness no greater than 500 nanometers. In some embodiments, the corrosion resistant layer has a thickness of from 80 nm to 250 nm. In some embodiments, the corrosion resistant layer has a thickness of at least 25 nanometers, at least 50 nanometers, at least 75 nanometers, at least 90 nanometers, or at least 100 nanometers. Additionally, in some embodiments, the corrosion resistant layer has a thickness no greater than 50 nanometers, no greater than 60 nanometers, no greater than 70 nanometers, no greater than 80 nanometers, no greater than 90 nanometers, no greater than 100 nanometers, no greater than 100 nanometers, no greater than 110 nanometers, no greater than 125 nanometers, no greater than 150 nanometers, no greater than 200 nanometers, no greater than 300 nanometers, no greater than 400 nanometers, or no greater than 500 nanometers.

Adhesive Layer

The adhesive layer is optional. Where present, the adhesive layer adheres the multilayer construction to a rigid substrate, which is different from the substrate layer on which the reflective layer is deposited. In some embodiments, the adhesive is a pressure sensitive adhesive. As used herein, the term “pressure sensitive adhesive” refers to an adhesive that exhibits aggressive and persistent tack, adhesion to a substrate with no more than finger pressure, and sufficient cohesive strength to be removable from the substrate. Exemplary pressure sensitive adhesives include those described in PCT Publication No. WO 2009/146227 (Joseph, et al.), incorporated herein by reference.

A solar mirror film comprising an adhesive layer defines a “laminatable” solar mirror film because it can be applied to a rigid substrate (see below).

Liner

The liner is optional. Where present, the liner protects the adhesive and allows the solar mirror film to be handled before being placed onto a rigid substrate. Such a configuration can then be conveniently packaged for transport, storage, and consumer use. In some embodiments, the liner is a release liner. In some embodiments, the liner is a silicone-coated release liner.

Rigid Substrate

The films described herein can be applied to a rigid substrate by removing the liner (where present) and placing an adhesive layer (where present) adjacent to the rigid substrate. Premask layer (where present) is then removed to expose the solar mirror film to sunlight. Suitable substrates generally share certain characteristics. Most importantly, the substrate should be sufficiently rigid. Second, the substrate should be sufficiently smooth that texture in the substrate is not transmitted through the adhesive/metal/polymer stack. This, in turn, is advantageous because it: (1) allows for an optically accurate mirror, (2) maintains physical integrity of the metal reflective layer by eliminating channels for ingress of reactive species that might corrode the metal reflective layer or degrade the adhesive, and (3) provides controlled and defined stress concentrations within the reflective film-substrate stack. Third, the substrate should be nonreactive with the reflective mirror stack to prevent corrosion. Fourth, the substrate should have a surface to which the adhesive durably adheres.

Exemplary substrates for reflective films, along with associated options and advantages, are described in PCT Publication Nos. WO04114419 (Schripsema), and WO03022578 (Johnston et al.); U.S. Publication Nos. 2010/0186336 (Valente, et al.) and 2009/0101195 (Reynolds, et al.); and U.S. Pat. No. 7,343,913 (Neidermeyer). For example, the article can be comprised in one of the many mirror panel assemblies as described in co-pending and co-owned provisional U.S. patent application Ser. No. 13/393,879 (Cosgrove, et al.) Other exemplary substrates include metals, such as, for example, aluminum, steel, glass, or composite materials.

UV Stabilizers

In some embodiments, the first outer layer or the protective layer, such as the hardcoat, independently of each other, may comprise a stabilizer such as a UV absorber (UVA) or hindered amine light stabilizer (HALS).

Ultraviolet absorbers function by preferentially absorbing ultraviolet radiation and dissipating it as thermal energy. In one embodiment, the UVA includes TINUVIN 477 and TINUVIN 479, available from BASF Corporation. Other suitable UVAs may include: benzophenones (hydroxybenzophenones, e.g., Cyasorb 531 (Cytec)), benzotriazoles (hydroxyphenylbenzotriazoles, e.g., Cyasorb 5411, Tinuvin 329 (Ciba Geigy)), triazines (hydroxyphenyltriazines, e.g., Cyasorb 1164), oxanilides, (e.g., Sanuvor VSU (Clariant)) cyanoacrylates (e.g., Uvinol 3039 (BASF)), or benzoxazinones. Suitable benzophenones include, CYASORB UV-9 (2-hydroxy-4-methoxybenzophenone, CHIMASSORB 81 (or CYASORB UV 531) (2 hydroxy-4 octyloxybenzophenone). Suitable benzotriazole UVAs include compounds available from Ciba, Tarrytown, N.Y. as TINUVIN P, 213, 234, 326, 327, 328, 405 and 571, and CYASORB UV 5411 and CYASORB UV 237. Other suitable UVAs include CYASORB UV 1164 (2-[4,6-bis(2,4-dimethylphenyl)-I,3,5-triazin-2yl]-5(oxctyloxy) phenol (an exemplary triazine), CYASORB 3638 (an exemplary benzoxiazine), Tin-1600, and SUKANO UV MASTERBATCH TA11-10 MB03.

Hindered amine light stabilizers (HALS) are efficient stabilizers against light-induced degradation of most polymers. HALS do not generally absorb UV radiation, but act to inhibit degradation of the polymer. HALS typically include tetra alkyl piperidines, such as 2,2,6,6-tetramethyl-4-piperidinamine and 2,2,6,6-tetramethyl-4-piperidinol. Other suitable HALS include compounds available from Ciba, Tarrytown, N.Y. as TINUVIN 123, 144, and 292.

The UVAs and HALS disclosed explicitly here are intended to be examples of materials corresponding to each of these two categories of additives. The present inventors contemplate that other materials not disclosed here but known to those skilled in the art for their properties as UV absorbers or hindered amine light stabilizers can be used in the durable dyed polyester films of this disclosure.

### Exemplary Embodiments

1. A multilayer optical film comprising:
   a first outer layer comprising one or more polymers,
   a core layer comprising a multilayer optical stack comprising two alternating polymeric layers, and
   a second outer layer comprising one or more polymers,
   wherein the first and second outer layers are separate from the multilayer optical stack,
   and
   wherein at least one or more of the following conditions is true:
      at least one of the polymers in the first outer layer is not present in the second outer layer,
      at least one of the polymers in the second outer layer is not present in the first outer layer.
2. The multilayer optical film according to claim 1, wherein the first outer layer comprises a blend of one or more acrylate polymers and one or more fluoropolymers.
3. The multilayer optical film according to any of the preceding claims, wherein the first outer layer comprises polymethyl(meth)acrylate.
4. The multilayer optical film according to any of the preceding claims, wherein the second outer layer comprises a polyester.
5. The multilayer optical film according to any of the preceding claims, wherein the second outer layer comprises polyethylene terephthalate.
6. The multilayer optical film according to any of the preceding claims, wherein the multilayer optical stack comprises alternating polymeric layers of a polyester and an acrylic polymer.
7. The multilayer optical film according to any of the preceding claims, wherein the multilayer optical stack comprises alternating polymeric layers of polyethylene terephthalate and a copolymer of polymethyl(meth)acrylate.
8. The multilayer optical film according to claim Error! Reference source not found., wherein the fluoropolymer is PVDF.
9. The multilayer optical film according to any of the preceding claims, wherein the multilayer optical film further comprises a metallic reflective layer adjacent the second outer layer.
10. The multilayer optical film according to claim 5, wherein the metal in the metallic reflective layer is chosen from gold, silver, aluminum, copper, nickel, titanium, and combinations thereof.
11. The multilayer optical film according to any of the preceding claims comprising a metallic reflective layer, wherein the multilayer optical film further comprises a corrosion resistance layer adjacent the metallic reflective layer.
12. The multilayer optical film according to claim 7, wherein the corrosion resistance layer comprises a metallic component chosen from copper, an inert metal alloy, and combinations thereof.
13. The multilayer optical film according to any of the preceding claims, wherein the multilayer optical film further comprises a hardcoat adjacent the first outer layer.
14. The multilayer optical film according to claim 9, wherein the hardcoat comprises one or more acrylate polymers.
15. The multilayer optical film according to claim 9, wherein the hardcoat comprises one or more UV absorbers.
16. The multilayer optical film according to claim 9, wherein the multilayer optical film does not comprise an adhesive or a primer between the first outer layer and the hardcoat.
17. The multilayer optical film according to any of the preceding claims, wherein the multilayer optical film further comprises a pressure sensitive adhesive and a liner as outermost layers.
18. The multilayer optical film according to any of the preceding claims, wherein the multilayer optical film comprises a reflective layer, and wherein the interlayer adhesion between the reflective layer and the second outer layer is degraded less than 20 percent of its original value after exposure to at least 100 MJ/m² UV.
19. The multilayer optical film according to any of the preceding claims, wherein the multilayer optical film comprises a reflective layer, and wherein the interlayer adhesion between the reflective layer and the second outer layer is degraded less than 20 percent of its original value after exposure to at least 350 MJ/m² UV.
20. The multilayer optical film according to any of the preceding claims, wherein the multilayer optical film comprises a hardcoat, and wherein the percent delamination between the hardcoat and the first outer layer in a cross-hatch adhesion test is less than 40 percent.
21. The multilayer optical film according to any of the preceding claims, wherein the multilayer optical film comprises a hardcoat, and wherein the percent delamination between the hardcoat and the first outer layer in a cross-hatch adhesion test is less than 20 percent.
22. A solar mirror film comprising:
   a hardcoat,
   a multilayer optical film, and
   a metallic reflective layer,
   wherein the multilayer optical film comprises:
      a first outer layer comprising one or more polymers,
      a core layer comprising a multilayer optical stack comprising two alternating polymeric layers, and
      a second outer layer comprising one or more polymers,
   wherein at least one or more of the following conditions is true:
      at least one of the polymers in the first outer layer is not present in the second outer layer,
      at least one of the polymers in the second outer layer is not present in the first outer layer.
23. The solar mirror film according to claim Error! Reference source not found., wherein the first outer layer of the multilayer optical film comprises a blend of one or more acrylate polymers and one or more fluoropolymers.
24. The solar mirror film according to any of the preceding claims directed to solar mirror films, wherein the first outer layer of the multilayer optical film comprises polymethyl(meth)acrylate.
25. The solar mirror film according to any of the preceding claims directed to solar mirror films, wherein the second outer layer of the multilayer optical film comprises a polyester.
26. The solar mirror film according to any of the preceding claims directed to solar mirror films, wherein the second outer layer of the multilayer optical film comprises polyethylene terephthalate.
27. The solar mirror film according to any of the preceding claims directed to solar mirror films, wherein the multilayer optical stack of the multilayer optical film comprises alternating polymeric layers of a polyester and an acrylic polymer.
28. The solar mirror film according to any of the preceding claims directed to solar mirror films, wherein the multilayer optical stack of the multilayer optical film comprises alternating polymeric layers of polyethylene terephthalate and a copolymer of polymethyl(meth)acrylate.
29. The solar mirror film according to claim Error! Reference source not found., wherein the fluoropolymer is PVDF.
30. The solar mirror film according to any of the preceding claims directed to solar mirror films, wherein the metal in the metallic reflective layer is chosen from gold, silver, aluminum, copper, nickel, titanium, and combinations thereof.
31. The solar mirror film according to any of the preceding claims directed to solar mirror films, wherein the multilayer optical film further comprises a corrosion resistance layer adjacent the metallic reflective layer.
32. The solar mirror film according to claim Error! Reference source not found., wherein the corrosion resistance layer comprises a metallic component chosen from copper, an inert metal alloy, and combinations thereof.
33. The solar mirror film according to any of the preceding claims directed to solar mirror films, wherein the hardcoat comprises one or more acrylate polymers.
34. The solar mirror film according to any of the preceding claims directed to solar mirror films, wherein the hardcoat comprises one or more UV absorbers.
35. The solar mirror film according to any of the preceding claims directed to solar mirror films, wherein the solar mirror film does not comprise an adhesive or a primer between the first outer layer and the hardcoat.
36. The solar mirror film according to any of the preceding claims directed to solar mirror films, wherein the solar mirror film further comprises a pressure sensitive adhesive and a liner as outermost layers.
37. The solar mirror film according to any of the preceding claims directed to solar mirror films, wherein the interlayer adhesion between the reflective layer and the second outer layer is degraded less than 20 percent of its original value after exposure to at least 100 MJ/m² UV.
38. The solar mirror film according to any of the preceding claims directed to solar mirror films, wherein the interlayer adhesion between the reflective layer and the second outer layer is degraded less than 20 percent of its original value after exposure to at least 350 MJ/m² UV.
39. The solar mirror film according to any of the preceding claims directed to solar mirror films, wherein the percent delamination between the hardcoat and the first outer layer in a cross-hatch adhesion test is less than 40 percent.
40. The solar mirror film according to any of the preceding claims directed to solar mirror films, wherein the percent delamination between the hardcoat and the first outer layer in a cross-hatch adhesion test is less than 20 percent.
41. A laminatable solar mirror film comprising:
   a hardcoat comprising one or more acrylate polymers and one or more UV absorbers,
   a multilayer optical film,
   a metallic reflective layer comprising a metal chosen from gold, silver, aluminum, copper, nickel, titanium, and combinations thereof, and
   a pressure sensitive adhesive,
   wherein the multilayer optical film comprises:
      a first outer layer comprising a blend of one or more acrylate polymers and one or more fluoropolymers,
      a core layer comprising a multilayer optical stack comprising two alternating polymeric layers a polyester and an acrylic polymer, and
      a second outer layer comprising a polyester,
   wherein the solar mirror film does not comprise an adhesive or a primer between the first outer layer and the hardcoat.
42. The laminatable solar mirror film according to claim 15, wherein the first outer layer of the multilayer optical film comprises polymethyl(meth)acrylate.
43. The laminatable solar mirror film according to any of the preceding claims directed to laminatable solar mirror films, wherein the second outer layer of the multilayer optical film comprises polyethylene terephthalate.
44. The laminatable solar mirror film according to any of the preceding claims directed to laminatable solar mirror films, wherein the multilayer optical stack of the multilayer optical film comprises alternating polymeric layers of polyethylene terephthalate and a copolymer of polymethyl(meth)acrylate.
45. The laminatable solar mirror film according to according to any of the preceding claims directed to laminatable solar mirror films, wherein the fluoropolymer is PVDF.
46. The laminatable solar mirror film according to any of the preceding claims directed to laminatable solar mirror films, wherein the multilayer optical film further comprises a corrosion resistance layer adjacent the metallic reflective layer.
47. The laminatable solar mirror film according to claim Error! Reference source not found., wherein the corrosion resistance layer comprises a metallic component chosen from copper, an inert metal alloy, and combinations thereof.
48. The laminatable solar mirror film according to any of the preceding claims directed to laminatable solar mirror films, further comprising a liner adjacent to the pressure sensitive adhesive.
49. A concentrated photovoltaic system, comprising the laminatable solar mirror film according to any of the preceding claims directed to laminatable solar mirror films and a rigid substrate.
50. A concentrated solar power system, comprising the laminatable solar mirror film according to any of the preceding claims directed to laminatable solar mirror films and a rigid substrate.
51. The laminatable solar mirror film according to any of the preceding claims directed to laminatable solar mirror films, wherein the interlayer adhesion between the reflective layer and the second outer layer is degraded less than 20 percent of its original value after exposure to at least 100 MJ/m² UV.
52. The laminatable solar mirror film according to any of the preceding claims directed to laminatable solar mirror films, wherein the interlayer adhesion between the reflective layer and the second outer layer is degraded less than 20 percent of its original value after exposure to at least 350 MJ/m² UV.
53. The laminatable solar mirror film according to any of the preceding claims directed to laminatable solar mirror films, wherein the percent delamination between the hardcoat and the first outer layer in a cross-hatch adhesion test is less than 40 percent.
54. The laminatable solar mirror film according to any of the preceding claims directed to laminatable solar mirror films, wherein the percent delamination between the hardcoat and the first outer layer in a cross-hatch adhesion test is less than 20 percent.

### EXAMPLES

Advantages and embodiments of this disclosure are further illustrated by the following examples, but the particular materials and amounts thereof recited in these examples, as well as other conditions and details, should not be construed to unduly limit this disclosure. These examples are merely for illustrative purposes and are not meant to be limiting on the scope of the appended claims. In these examples, all percentages, proportions and ratios are by weight unless otherwise indicated.

1,6-Hexanediol diacrylate (HDDA) is available from Sartomer USA, LLC, Exton, Pa., under the trade designation “SR238B”. PARALOID B48N copolymer is available from Dow Chemical, Midland, Mich. TINUVIN 477, TINUVIN 479, TINUVIN 123, IRGACURE 184, and IRGACURE 819 are all available from BASF Corporation North America, Florham Park, N.J. TEGO RAD 2250 is available from Evonik Tego Chemie GmbH, Essen, Germany. All poly(ethylene terephthalate) (PET), such as “PET 9921” and PET with an intrinsic viscosity of 0.74, was purchased from the Eastman Chemical Company, Kingsport, Tenn. PET with an intrinsic viscosity of 0.72 and a glass transition temperature of 78° C.-80° C. was prepared by 3M Company. Poly(vinylidene fluoride) (PVDF) was obtained under the trade designation “DYNEON PVDF 6008” from the 3M Company, St. Paul, Minn. Poly(methyl methacrylate) (PMMA) was obtained under the trade designation “CP-82,” from Plaskolite, Inc., Columbus, Ohio. “SUKANO UV MASTERBATCH TA11-10 MB03” was obtained from Sukano Polymers Corporation, Duncan, S.C. ATOGLAS 510A is a copolymer of methyl methacrylate and n-butyl methacrylate (nBMA) and was obtained from Arkema, King of Prussia, Pa.

### Example 1—Preparation of Coating Solution

The coating solution was prepared by combining the components of the formulation as shown in Table 1 below.

TABLE 1
Components of coating formulation.

| | Weight percent - | Weight percent - |
|---|---|---|
| Component | as formulated | dry basis |
| HDDA-SR238B | 42.60% | 79.85% |
| BASF Paraloid B44 | 6.40% | 12.00% |
| Tinuvin 477 | 1.43% | 2.68% |
| Tinuvin 479 | 1.43% | 2.68% |
| Tinuvin 123 | 0.47% | 0.88% |
| Irgacure 184 | 0.48% | 0.90% |
| IRGACURE 819 | 0.48% | 0.90% |
| Tegorad 2250 | 0.06% | 0.11% |
| Isopropanol | 23.33% | — |
| Toluene | 23.33% | — |

### Comparative Example 1—Coating on a Commercial Acrylic Solar Mirror Film

A reflective mirror film comprising an acrylic polymer layer and a metalized layer (obtained under the trade designation “SOLAR MIRROR FILM SMF-1100” from 3M Company, St. Paul, Minn.) was coated with the coating solution of Example 1. The coating solution was delivered to a web moving at 125 fpm through a slot-type coating die to a wet thickness of 20 μm and width of 49.5″. Solvents were removed in a 30 ft long convection oven with temperature varying throughout its length from 70° F. to 120° F. To be cured, the 9 μm dried coating entered a UV chamber equipped with a UV light source (from Fusion Systems Inc) where H-bulbs and D-bulbs were used.

This film was laminated onto a painted aluminum substrate having a thickness of approximately 0.02 in (0.05 cm) after removing the pressure sensitive adhesive liner on the metalized side. The aluminum substrate was then cut into samples using a shear cutter.

### Comparative Example 2—Symmetric Multilayer Optical Film with Acrylate Outer Layers

A multilayer optical film was prepared as follows: a multilayer optical stack was prepared by co-extruding first and second polymer layers through a multilayer polymer melt manifold to create a multilayer melt stream having 650 alternating layers. The first polymer layer of the multilayer stack was a birefringent layer comprising PET 9921. The second polymer layer comprised ATOGLAS 510A. Two polymeric outer layers each having a thickness of approximately 9 microns were also co-extruded as protective layers on each side of the optical layer stack. Each of the outer layers comprised a polymer blend comprising 35 weight percent PVDF, 44 weight percent PMMA, and 21 weight percent SUKANO UV MASTERBATCH TA11-10 MB03. The multilayer melt stream with outer layers was cast onto a chilled roll creating a multilayer cast web. The multilayer cast web was then heated in a length orienter to a temperature of about 105° C. and uniaxially oriented to a draw ratio of 3.6. The web was then heated in a tenter oven to a temperature of about 105° C. prior to being uniaxially oriented to a draw ratio of 3.6.

The coating solution of Example 1 was coated onto one side of the biaxially oriented multilayer cast web. The coating solution was delivered to a web moving at 125 fpm through a slot-type coating die to a wet thickness of 20 μm and width of 49.5″. Solvents were removed in a 30 ft long convection oven with temperature varying throughout its length from 70° F. to 120° F. To be cured, the 9 μm dried coating entered a UV chamber equipped with a UV light source (from Fusion Systems Inc) where H-bulbs and D-bulbs were used.

A layer of silver approximately 100 nm thick was vapor deposited onto the film substrate on the side opposite the cured coating. A copper layer approximately 80 nm thick was coated onto the silver layer. A 25 micron thick layer of acrylic adhesive was coated onto the copper layer and a release liner applied.

This film was laminated onto a painted aluminum substrate having a thickness of approximately 0.02 in (0.05 cm) after removing the pressure sensitive adhesive liner on the metalized side. The aluminum substrate was then cut into test specimens using a shear cutter.

### Comparative Example 3—Symmetric Multilayer Optical Film with PET Outer Layers

A multilayer optical film was prepared as follows: a multilayer optical stack was prepared by co-extruding first and second polymer layers through a multilayer polymer melt manifold to create a multilayer melt stream having 650 alternating layers. The first polymer layer of the multilayer stack was a birefringent layer comprising PET 9921. The second polymer layer comprised ATOGLAS 510A. Two outer layers each having a thickness of approximately 9 microns were also co-extruded as protective layers on each side of the optical layer stack. Each of the outer layers comprised PET with an Inherent Viscosity of 0.74 from Eastman Chemical Co. The multilayer melt stream with outer layers was cast onto a chilled roll creating a multilayer cast web. The multilayer cast web was then heated in a length orienter to a temperature of about 105° C. and uniaxially oriented to a draw ratio of 3.6. The web was then heated in a tenter oven to a temperature of about 105° C. prior to being uniaxially oriented to a draw ratio of 3.6.

The coating solution of Example 1 was coated onto one side of the biaxially oriented multilayer cast web. The coating solution was delivered to a web moving at 125 fpm through a slot-type coating die to a wet thickness of 20 μm and width of 49.5″. Solvents were removed in a 30 ft long convection oven with temperature varying throughout its length from 70° F. to 120° F. To be cured, the 9 μm dried coating entered a UV chamber equipped with a UV light source (from Fusion Systems Inc) where H-bulbs and D-bulbs were used.

A layer of silver approximately 100 nm thick was vapor deposited onto the film substrate on the side opposite the cured coating. A copper layer approximately 80 nm thick was coated onto the silver layer. A 25 micron thick layer of acrylic adhesive was coated onto the copper layer and a release liner applied.

This film was laminated onto a painted aluminum substrate having a thickness of approximately 0.02 in (0.05 cm) after removing the pressure sensitive adhesive liner on the metalized side. The aluminum substrate was then cut into test specimens using a shear cutter.

### Example 2—Multilayer Optical with Asymmetric Outer Layers

A multilayer optical film was prepared as following: a multilayer optical stack was prepared by co-extruding first and second polymer layers through a multilayer polymer melt manifold to create a multilayer melt stream having 650 alternating layers. The first polymer layer of the multilayer stack was a birefringent layer comprising PET 9921. The second polymer layer comprised ATOGLAS 510A. Two outer layers each having a thickness of approximately 9 microns were also co-extruded as protective layers on each side of the optical layer stack. A first outer layer comprised a polymer blend comprising 35 weight percent PVDF, 44 weight percent PMMA, and 21 weight percent SUKANO UV MASTERBATCH TA11-10 MB03. A second outer layer comprised PET with an Inherent Viscosity of 0.72 from 3M Company.

The multilayer melt stream with outer layers was cast onto a chilled roll creating a multilayer cast web. The multilayer cast web was then heated in a length orienter to a temperature of about 105° C. and uniaxially oriented to a draw ratio of 3.6. The web was then heated in a tenter oven to a temperature of about 105° C. prior to being uniaxially oriented to a draw ratio of 3.6.

The coating solution of Example 1 was coated onto the PMMA/PVDF side of the biaxially oriented multilayer cast web. The coating solution was delivered to a web moving at 125 fpm through a slot-type coating die to a wet thickness of 20 μm and width of 49.5″. Solvents were removed in a 30 ft long convection oven with temperature varying throughout its length from 70° F. to 120° F. To be cured, the 9 μm dried coating entered a UV chamber equipped with a UV light source (from Fusion Systems Inc) where H-bulbs and D-bulbs were used.

A layer of silver approximately 100 nm thick was vapor deposited onto the PET side of the film substrate. A copper layer approximately 80 nm thick was coated onto the silver layer. A 25 micron thick layer of acrylic adhesive was coated onto the copper layer and a release liner applied.

This film was laminated onto a painted aluminum substrate having a thickness of approximately 0.02 in (0.05 cm) after removing the pressure sensitive adhesive liner on the metalized side. The aluminum substrate was then cut into test specimens using a shear cutter.

### Testing of Films

The test specimens comprising MOF-containing films laminated to painted aluminum substrates that were conditioned and tested as described below.

### Conditioning of Film—Accelerated Weathering

Accelerated weathering was accomplished in a weathering device (Q-SUN Xe-3 Xenon Test Chamber from Q-Lab Corporation). Samples followed the protocol outlined in ASTM G155. The samples were placed into an environmental chamber with Xenon arc lamp and daylight filters with irradiance of at 0.68 W/m² at 340 nm and black panel temperature at 70° C. In some instances, samples were conditioned in a weathering device (Ci5000 Weather-Ometer® from Atlas Material Testing Technology) at an irradiance of >0.68 W/m² at 340 nm and black panel temperature at 70° C. with various dosage levels.

### Conditioning of Film—Natural Weathering

Outdoor exposure was accomplished for 2 weeks in St Paul, Minn., with sample facing south at an inclination angle of 45 degrees.

### Cross-Hatch Adhesion Testing

Adhesion testing was performed according to ASTM method D3359. The coated surfaces of films from the above examples were scribed using a razor blade tool to produce a 5×5 grid pattern of 1 mm×1 mm squares. Transparent acrylic adhesive tape (commercially available from 3M) was then placed into contact with the scribed surface. After a dwell time of one minute the tape was peeled away and the film inspected for coating removal within the scribed grid area.

Sample numbers starting with 1 in Table 2 were of the film described in Comparative Example 1 and characterized with criteria of 0, “<20%”, or “>20%”.

Sample numbers starting with 2 in Table 2 were of the film described in Comparative Example 2 and characterized by estimation of area affected.
Sample numbers starting with 3 in Table 2 were of the film described in Comparative Example 3 and characterized by estimation of area affected.
Sample numbers starting with 4 in Table 2 were of the film described in Example 2 and characterized by estimation of area affected.

The results of this testing are presented in Table 2 and show that adhesion of the surface protective coating to an acrylate surface in sample sets 1, 2, and 4 are good while adhesion of the surface protective coating to a PET surface in sample set 3 is poor.

TABLE 2
Cross-hatch adhesion test results.

| | Percent |
|---|---|
| | delamination |
| SampleComparative | |
| Example 1 | |
| 1.01 | <20 |
| 1.02 | <20 |
| 1.03 | <20 |
| 1.04 | <20 |
| 1.05 | <20 |
| 1.06 | <20 |
| 1.07 | <20 |
| 1.08 | <20 |
| 1.09 | <20 |
| 1.10 | <20 |
| 1.11 | <20 |
| 1.12 | <20 |
| 1.13 | 0 |
| 1.14 | 0 |
| SampleComparative | |
| Example 2 | |
| 2.01 | 0 |
| 2.02 | 0 |
| 2.03 | 0 |
| 2.04 | 10 |
| 2.05 | 15 |
| 2.06 | 0 |
| SampleComparative | |
| Example 3 | |
| 3.01 | 100 |
| 3.02 | 100 |
| 3.03 | 100 |
| 3.04 | 100 |
| 3.05 | 100 |
| 3.06 | 100 |
| Sample | |
| Example 2 | |
| 4.01 | 0 |
| 4.02 | 0 |
| 4.03 | 40 |
| 4.04 | 0 |
| 4.05 | 0 |
| 4.06 | 0 |
| 4.07 | 0 |
| 4.08 | 0 |
| 4.09 | 0 |
| 4.10 | 0 |
| 4.11 | 0 |
| 4.12 | 0 |
| 4.13 | 0 |
| 4.14 | 0 |
| 4.15 | 0 |

### Interlayer Adhesion Testing

ASTM method D6862-11 that was modified by using preconditioned samples. Samples measuring 0.5 inch×11 inch were preconditioned in a deionized water bath for at least 12 hours to completely saturate the polymer layers and avoid polymer fracture during testing. Samples were conditioned in an accelerated weathering chamber using to a xenon arc source with daylight filters per ASTM G155 operating at 0.68 W/m²/nm at 340 nm with black panel temperature of 70° C. The exposures were completed according to the UV dosage shown in the table. “UV dosage” in the Table refers to the UV conditioning dosage (MJ/m² UV).

TABLE 3
Interlayer adhesion test results in pound-force per 0.5″.

| | | | | Comparative | | |
|---|---|---|---|---|---|---|
| | | | Comparative | Example 3 - | | Example 2 - |
| | Comparative | | Example 2 - | MOF with | | MOF with |
| | Example 1 - | | MOF with | symmetric PET | | asymmetric |
| | SMF1100 | | symmetric acrylate | outer layers | | outer layers |
| wet peel | Example | | outer layers | Example | | Example |
| UV dosage | Sample #1.15 | UV dosage | Sample #2.07 | Sample #3.07 | UV dosage | Sample #4.16 |
| (MJ/m² UV) | (lbf/½ inch) | (MJ/m² UV) | (lbf/½ inch) | (lbf/½ inch) | (MJ/m² UV) | (lbf/½ inch) |
| 0.0 | 2.06 | 0.0 | 0.86 | 2.22 | 0.0 | 2.22 |
| 8.7 | 1.09 | 9.1 | 0.68 | 2.14 | 37.9 | 2.36 |
| 17.4 | 0.81 | 18.2 | 0.12 | 2.50 | 189.5 | 2.71 |
| 34.8 | 0.30 | 36.4 | 0.10 | 2.49 | 379.0 | 2.64 |
| 69.5 | 0.13 | 379.0 | | 1.94 | | |

The results of the interlayer adhesion testing are summarized in Table 3 and show adhesion of the silver layer to acrylate layer in Comparative Examples 1 and 2 is degraded to a low level over dosage while adhesion of the silver layer to PET in Comparative Example 3 and Example 2 are stable over dosage.

### Delamination Resistance on Exposure to Salt Solution

Samples were placed in a solution of 1% sodium chloride in deionized water at room temperature and evaluated daily. Delamination areas were marked and measured. Failure was defined as more than 0.25 inch delamination.
Sample numbers starting with 1 were from Comparative Example 1.
Sample numbers starting with 2 were from Comparative Example 2.
Sample numbers starting with 3 were from Comparative Example 3.
Sample numbers starting with 4 were from Example 2.
Laminated samples (1.16, 1.17, 2.08, 2.09, 3.08 and 3.09) were sheared into 12″×12″ squares and conditioned with natural exposure of approximately 7 MJ/m² UV. The samples were placed into a solution of 1% NaCl in deionized water at room temperature. Soaking in a salt water bath stressed the film samples to a greater degree than a deionized water soak. Samples were evaluated daily. Delamination areas are marked and measured. Samples were characterized with a criteria of “<0.25 inch” or “>0.25 inch” delamination. Samples with areas >0.25 inch delamination were considered to have failed.

TABLE 4
Delamination test in which 12 inch by 12 inch
samples were preconditioned by natural outdoor exposure
of approximately 7 MJ/m² UV.

| | 2 | 7 | 12 | 14 | 20 | 21 | 26 |
|---|---|---|---|---|---|---|---|
| | days | days | days | days | days | days | days |
| Example | failure | | | | | | |
| Sample #1.16 | | | | | | | |
| Example | failure | | | | | | |
| Sample #1.17 | | | | | | | |
| Example | failure | | | | | | |
| Sample #2.08 | | | | | | | |
| Example | pass | pass | pass | pass | pass | pass | pass |
| Sample #2.09 | | | | | | | |
| Example | pass | pass | pass | pass | pass | pass | pass |
| Sample #3.08 | | | | | | | |
| Example | pass | pass | pass | pass | pass | pass | pass |
| Sample #3.09 | | | | | | | |

Laminated samples (1.18, 2.10, 2.11, 4.17, 4.18 and 4.19) were sheared into 6″×6″ squares and conditioned with accelerated exposure to increase the level of stress on the samples. These samples received approximately 26 MJ/m² UV (285-385 nm) exposure to a xenon arc source with daylight filters per ASTM G155 operating at 0.68 W/m²/nm at 340 nm with black panel temperature of 70° C. The samples were placed into a solution of 1% NaCl in deionized water at room temperature. Samples were evaluated daily. Delamination areas were marked and measured. Samples were characterized with criteria of percentage of delamination. Samples with a percentage greater than 20% were considered to have failed.

TABLE 5
Delamination test in which 6 inch by 6 inch samples
were preconditioned by 26 MJ/m² UV exposure.

| | 1 day | 14 days | 21 days |
|---|---|---|---|
| Example | failure | | |
| Sample #1.18 | | | |
| Example | failure | | |
| Sample #2.10 | | | |
| Example | pass | pass | not |
| Sample #2.11 | | | tested |
| Example | pass | pass | pass |
| Sample #4.17 | | | |
| Example | pass | pass | pass |
| Sample #4.18 | | | |

The results of the delamination testing summarized in Tables 4 and 5 show adhesion of silver to the PET layer in sample lots 3 and 4 is more durable under stress than adhesion of silver to the acrylate layers in sample lots 1 and 2.

1. A multilayer optical film comprising:
a first outer layer comprising one or more polymers,
a core layer comprising a multilayer optical stack comprising two alternating polymeric layers, and
a second outer layer comprising one or more polymers,
wherein the first and second outer layers are separate from the multilayer optical stack,
wherein the multilayer optical stack has two major surfaces;
wherein each of the first outer layer and the second outer layer is adjacent to one of the major surfaces of the multilayer optical stack; and
wherein at least one or more of the following conditions is true:
at least one of the polymers in the first outer layer is not present in the second outer layer,
at least one of the polymers in the second outer layer is not present in the first outer layer.

2. The multilayer optical film according to claim 1, wherein the multilayer optical stack comprises alternating polymeric layers of a polyester and an acrylic polymer.

3. The multilayer optical film according to claim 1, wherein the multilayer optical stack comprises alternating polymeric layers of polyethylene terephthalate and a copolymer of polymethyl(meth)acrylate.

4. The multilayer optical film according to claim 1, wherein the first outer layer comprises PVDF.

5. The multilayer optical film according to claim 1, wherein the multilayer optical film further comprises a metallic reflective layer adjacent the second outer layer.

6. The multilayer optical film according to claim 5, wherein the metal in the metallic reflective layer is chosen from gold, silver, aluminum, copper, nickel, titanium, and combinations thereof.

7. The multilayer optical film according to claim 1 comprising a metallic reflective layer, wherein the multilayer optical film further comprises a corrosion resistance layer adjacent the metallic reflective layer.

8. The multilayer optical film according to claim 7, wherein the corrosion resistance layer comprises a metallic component chosen from copper, an inert metal alloy, and combinations thereof.

9. The multilayer optical film according to claim 1, wherein the multilayer optical film further comprises a hardcoat adjacent the first outer layer.

10. The multilayer optical film according to claim 9, wherein the hardcoat comprises one or more acrylate polymers and one or more UV absorbers.

11. The multilayer optical film according to claim 9, wherein the multilayer optical film does not comprise an adhesive or a primer between the first outer layer and the hardcoat.

12. The multilayer optical film according to claim 1, wherein the multilayer optical film further comprises a pressure sensitive adhesive and a liner as outermost layers.

13. The multilayer optical film according to claim 1, wherein the multilayer optical film comprises a reflective layer, and wherein the interlayer adhesion between the reflective layer and the second outer layer is degraded less than 20 percent of its original value after exposure to at least 100 MJ/m² UV.

14. The multilayer optical film according to claim 1, wherein the multilayer optical film comprises a hardcoat, and wherein the percent delamination between the hardcoat and the first outer layer in a cross-hatch adhesion test is less than 40 percent.

15. A laminatable solar mirror film comprising:
a hardcoat comprising one or more acrylate polymers and one or more UV absorbers,
a multilayer optical film,
a metallic reflective layer comprising a metal chosen from gold, silver, aluminum, copper, nickel, titanium, and combinations thereof, and
a pressure sensitive adhesive,
wherein the multilayer optical film comprises:
a first outer layer comprising a blend of one or more acrylate polymers and one or more fluoropolymers,
a core layer comprising a multilayer optical stack comprising two alternating polymeric layers a polyester and an acrylic polymer, and
a second outer layer comprising a polyester,
wherein the solar mirror film does not comprise an adhesive or a primer between the first outer layer and the hardcoat.
